(19) United States
(12) Patent Application Publication
(10) Pub. No.: US 2013/0326959 A1
(43) Pub. Date: Dec. 12, 2013

(54) MECHANICAL GATE OPENER FOR LIVESTOCK CHUTES

(71) Applicant: Tommie Carroll Gipson, Eaton, CO (US)

(72) Inventor: Tommie Carroll Gipson, Eaton, CO (US)

(21) Appl. No.: 13/753,140

(22) Filed: Jan. 29, 2013

Related U.S. Application Data
(60) Provisional application No. 61/689,751, filed on Jun. 12, 2012.

(51) Int. Cl. E05F 15/02

(52) U.S. Cl. CPC E05F 15/02
USPC 49/357

(57) ABSTRACT

A mechanical gate opener is used to activate an opening mechanism for a livestock chute. The gate opener includes a weight, an elevating mechanism for lifting the weight to a set height, and a delay mechanism for extending the time from when the weight is released from the set height to when the weight strikes an actuator for the gate opening mechanism. One embodiment of the gate opener includes a diverter for diverting the released weight to prevent the weight from striking the actuator and initiating the gate opening.

### CROSS-REFERENCE TO RELATED APPLICATION

The present application, pursuant to 35 U.S.C. 111(b), claims the benefit of the earlier filing date of provisional application Ser. No. 61/689,751 filed Jun. 6, 2012, and entitled “Roping Chute.”

### BACKGROUND OF THE INVENTION

1. Field of the Invention

The present invention relates to a gate opener for a livestock chute. In particular, the present invention relates to a mechanical gate opener having a delay mechanism fir dropping a weight on an actuator to trigger an opening mechanism for an exit gate of a livestock chute.

2. Description of the Related Art

Rodeo contests have become popular in recent years, particularly in the western states of the United States, and many cowboys and other western riders have become highly skilled in the performance of certain cattle handling feats, such as bulldogging, steer-roping, and calf-roping. Roping, for example, is increasingly popular as a family sport and today there are more than 100,000 members in the United States Team Roping Association. Ropers often exhibit their skills in competitions where they actively compete with each other for prize money before large audiences during rodeo performances.

Generally these events requires that a steer or a calf be brought into a holding chute having a gate which can be selectably opened and closed for the entrance, retention, and release of the animal. Holding chutes provided with entry and exit gates are also traditionally used by rodeo performers to temporarily hold and release cattle for mounted roping practice.

A roping chute typically consists of a narrow, short pen having both an entry and an exit gate. The earliest roping chutes were manually operated. After a bovine, typically a calf, was induced to enter a roping chute which had its exit gate initially latched, a person latched the entry gate. Then, when the roper was ready, the exit gate was manually unlatched so that the calf could exit into the larger roping pen.

Recently, electrically powered roping pens operated by a handheld remote control have been developed. However, that type of chute was expensive and required a power source such as a charged battery. In addition, the remote control was subject to being dropped or mislaid by the roper.

A need exists for an improved roping chute which uses minimal or no electrical or other externally provided power to control its operation. A further need exists for an improved roping chute that can be operated solely by a horseman who can remain mounted for the passage of a bovine through the chute.

### SUMMARY OF THE INVENTION

The present invention relates to a mechanical gate opener used to activate an opening mechanism for a livestock chute. The gate opener includes a weight, an elevating mechanism for lifting the weight to a set height, and a delay mechanism for extending the time from when the weight is released from the set height to when the weight strikes an actuator for the gate opening mechanism. One embodiment of the gate opener includes a diverter for diverting the released weight to prevent the weight from striking the actuator and initiating the gate opening.

One embodiment of the present invention is a gate opener for opening a gate including: a weight; a gate opening mechanism; an actuator for the gate opening mechanism, wherein the weight striking the actuator initiates the opening of the exit gate; an elevating mechanism for lifting the weight a set height; a release mechanism for releasing the weight at the set height; and a delay mechanism for extending a time from when the weight is released from the set height to when the weight strikes the actuator.

Another embodiment of the present invention is a gate opener for opening an exit gate of a livestock chute including: a) a gate opening mechanism including a rotating linkage, wherein when the rotating linkage is in a first stable position the opening mechanism resists opening the exit gate to an opening force and when the rotating linkage is in a second unstable position the exit gate opens in response to the opening force; b) an actuator for the gate opening mechanism having a flipper bar rotatable between a resting position and a striking position, the flipper bar having a first end and a second end, wherein the second end is positioned under one end of the rotating linkage when the flipper bar is in the resting position; and c) an actuator control having (i) a weight, (ii) an elevating mechanism for lifting the weight a set height, (iii) a release mechanism for releasing the weight at the set height; and (iv) a delay mechanism for extending a time from when the weight is released from the set height to when the weight strikes the first end of the flipper bar in the resting position to rotate the flipper bar to the striking position wherein the second end of the flipper bar impacts the one end of the rotating linkage causing the linkage to rotate to the unstable position.

Yet another embodiment of the present invention is a gate opener for opening an exit gate of a livestock chute including: a) a gate opening mechanism including a rotating linkage, wherein when the rotating linkage is in a first stable position the opening mechanism resists opening the exit gate to an opening force and when the rotating linkage is in a second unstable position the exit gate opens in response to the opening force; b) an actuator for the gate opening mechanism having a flipper bar rotatable between a resting position and a striking position, the flipper bar having a first end and a second end, wherein the second end is positioned under one end of the rotating linkage when the flipper bar is in the resting position; and c) an actuator control having a housing that encloses (i) a ball, (ii) a lift tray for an elevating the ball a set height, (iii) a release mechanism for releasing the weight at the set height, and (iv) a series of inclined ramps, wherein the series of ramps are positioned such that the hall rolls downward from a first ramp onto a second ramp and then onto a third ramp before striking the first end of the flipper bar in the resting position to rotate the flipper bar to the striking position thereby impacting one end of the rotating linkage to rotate it to the second unstable position.

The foregoing has outlined rather broadly several aspects of the present invention in order that the detailed description of the invention that follows may be better understood. Additional features and advantages of the invention will be described hereinafter which form the subject of the claims of the invention. It should be appreciated by those skilled in the art that the conception and the specific embodiment disclosed might be readily utilized as a basis for modifying or redesigning the structures for carrying out the same purposes as the invention. It should be realized by those skilled in the art that such equivalent constructions do not depart from the spirit and scope of the invention as set forth in the appended claims.

### BRIEF DESCRIPTION OF THE DRAWINGS

For a more complete understanding of the present invention, and the advantages thereof, reference is now made to the following descriptions taken in conjunction with the accompanying drawings, in which:

FIG. 1 is an oblique view taken from the right rear of the roping chute with the first embodiment of the actuator control mounted thereon.

FIG. 2 corresponds to FIG. 1, but is taken from the left rear looking downwardly with the entry gate open.

FIG. 3 is a side view of the chute configuration when a calf (not shown) is within and is the configuration of the chute prior to triggering the actuator of the exit gate latching and release mechanism.

FIG. 4 is a side view of the gate latching and release mechanism.

FIG. 5 is an oblique view from above of the gate latching and release mechanism of FIG. 4.

FIG. 6 shows a side view of the gate latching and release mechanism after the exit gate is opened.

FIG. 7 is an oblique view of the chute configuration shown in FIG. 3 further showing the first embodiment of the actuator control with the lift line protruding from the top of the actuator control housing and attached to a stationary object.

FIG. 8 is a righthand side view of the actuator control assembly in its inactive mode and with the cover removed.

FIG. 9 is a side view of the actuator control corresponding to FIG. 8, but with the lift tray raised by the rider so that the ball can begin rolling down the indicated ball path.

FIG. 10 shows the ball after its weight has depressed the trigger bar to cause the exit gate to open.

FIG. 11 corresponds to FIG. 9, but with the diverter engaged so that the released ball is deflected by an operator imposed obstacle from impacting the target surface of the trigger bar.

FIG. 12 is an oblique view of the tope of the roping chute with the second embodiment of the actuator control mounted thereon.

FIG. 13 is a side view of the second embodiment of the actuator control with the ball shown falling towards the target surface of the flipper bar.

FIG. 14 is an oblique view of the second embodiment of the actuator control showing the configuration of the exit gate latching and release mechanism immediately after the calf has departed the pen through the opened exit gate.

### DESCRIPTION OF THE PREFERRED EMBODIMENTS

Embodiments of the present invention relate to a mechanical gate opener used to activate an opening mechanism for a livestock chute. The gate opener includes a weight, an elevating mechanism for lifting the weight to a set height, and a delay mechanism for extending the time from when the weight is released front the set height to when the weight strikes an actuator for the gate opening mechanism. One embodiment of the gate opener includes a diverter for diverting the released weight to prevent the weight from striking the actuator and initiating the gate opening.

The roping chute used with the gate opener can vary in size and construction. Certain aspects of the gate opener were designed to work with a livestock chute used for roping. However, the gate opener can be used with a variety of different chute designs, for example the gate opener can also be used with chutes used for livestock weighing and veterinary care.

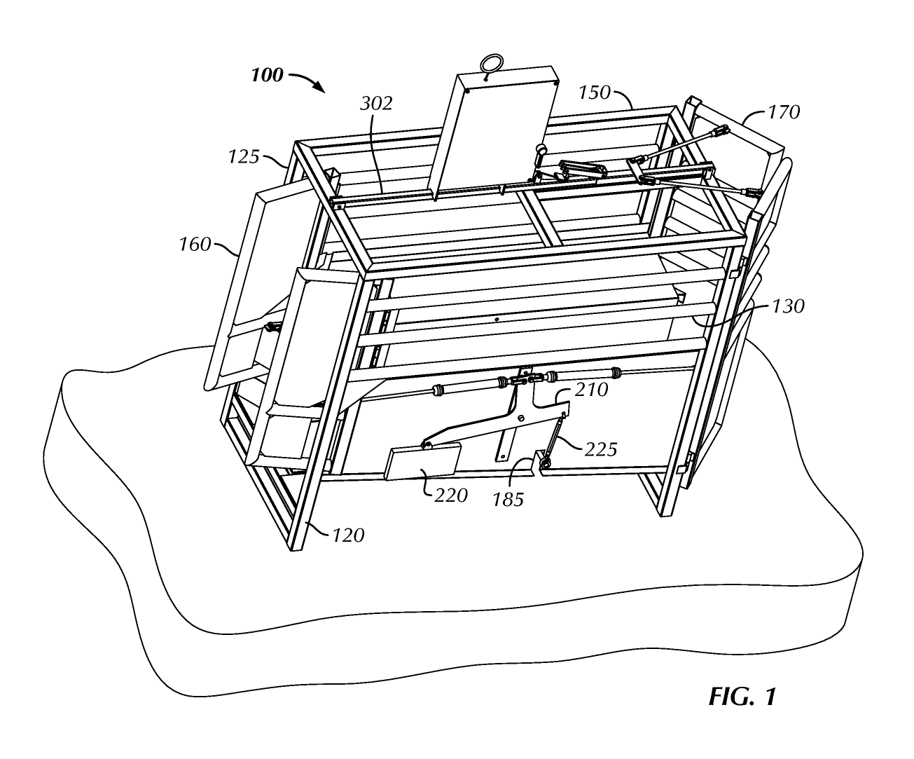

The preferred roping chute is a relatively short, narrow pen having both an automatically closing normally open entry gate and a selectively opening exit gate. The preferred roping chute is illustrated in FIG. 1. Closure of the entry gate is caused by the downward movement of a pivoting floor of the chute in response to the weight of an animal entering the chute. Following entrapment of the animal in the chute, the opening of the exit gate is effected by a selectively applied weight to an actuator of a gate opening mechanism or latch release.

There are two mechanisms of operation for the gate opener. One mechanism releases a weight, such as a trigger ball, to hit the actuator of the gate opening mechanism to open the exit gate. The second mechanism selectively diverts the weight to miss hitting the latch release and does not open the exit gate. The second mechanism is used to train a horse not to move forward at the sound of the falling weight, but to wait for its rider command.

When the exit gate is opened the animal enclosed in the chute departs through the exit gate. Removal of the weight of the animal from the pivoting floor permits the pivoting floor to rise by action of a counterweight, thereby energizing springs which urge the exit to close and the entry gate to open ready for the next animal to enter the chute. In addition, the latch release is returned to its original, untriggered position so that the chute operating cycle can be repeated.

The materials of the present invention are typically steel. The gate structure is fabricated primarily of tubing and plate, with some rolled sections such as angles also being used. The structural connections are made by arc welding or other fastening means. Commercially available hardware fittings are also utilized.

Basic Structure of the Chute

The gate opener can work with a variety of different chute designs. For example, the gate opener can be used with chutes designed for livestock weighing and veterinary care as well as chutes used in calf roping.

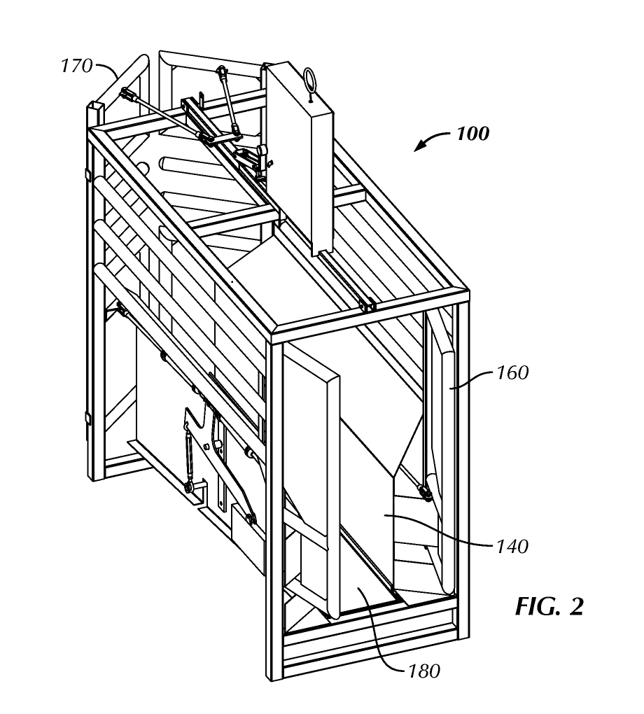

One embodiment of a livestock chute suitable for use with the gate opener is described below. Referring to FIGS. 1 and 2, the roping chute 100 is shown in its open position ready to receive a calf. In this position, the entry gate is open, the pivoting floor is up, and the exit gate is closed. The chute is a narrow pen having a floor pivoting about a transverse axis at its entry end, closely spaced mirror image sides, an upper structure which mounts a gate opening mechanism, an entry gate 160, and an exit gate 170.

The roping chute 100 is placed on the ground 11. The chute primary structure consists of mirror image side frames 120 connected at the lower entry end by a pair of horizontal tubes constituting an entry cross connection structure.

The side frames 120 of the chute are also connected at the lower exit end by an exit cross tube. At its top, the chute 100 has its side frames 120 connected by a top frame 150. Each side frame 120 consists of two parallel spaced apart rectangular vertical tubular end posts 125 joined by multiple horizontal round tubes 130.

The entry cross connection structure consists of two vertically spaced apart horizontal rectangular tubes, with the lower tube at the bottom ends of the side frames 120. The upper tube of the cross connection structure mounts a pair of inwardly extending symmetrically spaced apart vertical axis floor hinge plates having transverse holes for mounting of the movable floor assembly. The exit cross tube is also located at the bottom ends of the side frames 120.

Press-broken plates serve as mirror image guide plates 140. The guide plates 140 extend horizontally between the entry side of the side frame 120 to the end post 125 at the exit end of the side frame. The guide plates 140 generally have a short first vertical section, a horizontal inward bend at approximately 45° from vertical, a second flat segment extending inwardly, a second horizontal outward bend to produce a vertical third section, and a short horizontally outwardly extending stiffening edge.

The top frame 150, seen in FIG. 1, has a rectangular perimeter frame made of rectangular tubing. The top frame 150 is welded at its corners to the tops of the end posts 125 of the side frames 120. The top frame 150 has a transverse rectangular cross tube spanning between its longer sides at approximately midlength.

The movable floor assembly is a narrow elongated flat floor plate 180 having longitudinal stiffeners on the upper side of the plate on its sides. The floor 180 is slightly longer than the primary structure of the chute 100, and its width is such that it has a slip fit between the vertical third sections of the opposed lower guide plates 140. At its entry end, a transverse hinge tube is mounted under the floor plate 180 to serve as a pivot axis engaged in the holes of the vertical floor mount plates which project from the upper tube of the entry cross connection structure. The movable floor assembly thus has its entry end pivoted, while the exit end is able to displace vertically generally about 6 to 12 inches.

In addition, a transverse cylindrical bar is mounted under the floor plate 180. Each outer end of the transverse bar, or a projection 185 thereof is engaged with the lower end of a floor link 225.

The Gate Operator Linkage Assembly

A gate operator linkage assembly 200 is mounted on the outside of the vertical third section of each of the lower guide plates 140 as shown in FIGS. 1, 2 and 3. The gate operator linkage assemblies 200 apply the opening and closing forces to the entry gates 160 and the exit gates 170 using a pivoting gate operator bar 210, a counterweight 220, an entry gate operating link 230, and an exit gate operating link 240. Each pivoting gate operator bar 210 is rotationally mounted on a short stub shaft projecting transversely from the lower side of a guide plate 140.

The gate operator bar 210 has a toe shape with a short transverse arm projecting upwardly from the main part of the operator bar. The rotational shaft mounting hole is located close to the intersection of the tee arms. All three ends of the gate operator bar 210 have transverse holes.

The hole of the longest branch of the operator bar pivotably mounts a counterweight 220. For the gate operator bar 210 shown in FIG. 1, the counterweight 220 provides a counterclockwise torque urging the pivoting floor 180 upward. Unless otherwise restrained, the counterweight biasing force is sufficient to close the exit gate 170, open the entry gate 160, and to fully raise the pivoting floor 180 of the chute 100.

The hole at the opposed end of the operator bar 210 is attached to a floor link 225 connecting the operator bar 210 to the pivoting floor 180. The floor link 225 is a turnbuckle having a circular eye on a first end and a hook on a second end. The circular eye is coaxially engaged with the transverse bar of the movable floor 180 and the hook is engaged with an arm of the operator bar 210.

A pair of holes is located at the end of the upwardly projecting arm of the operator bar 210. One hole provides an attachment point for an entry gate operating link 230 attached to an entry gate 160. The other hole provides an attachment point for an exit gate operating link 240 attached to an exit gate 170.

Each gate operating link typically consists of a swivelable jaw end fitting with a pin mounted on a rod extending from a spring housing. The spring housing houses a compression spring which acts against a transverse head of the rod to urge the rod outwardly relative to the spring housing. The end of the spring housing opposed to the rod end mounts a second swivelable jaw end fitting with a pin. The spring housing of a gate rod assembly optionally can be fluid filled and the piston relatively closely fitted to the bore of the spring housing in order to provide either unidirectional or bidirectional hydraulic damping to axial dimensional change for the gate rod assemblies.

Gate Latching and Release Mechanism

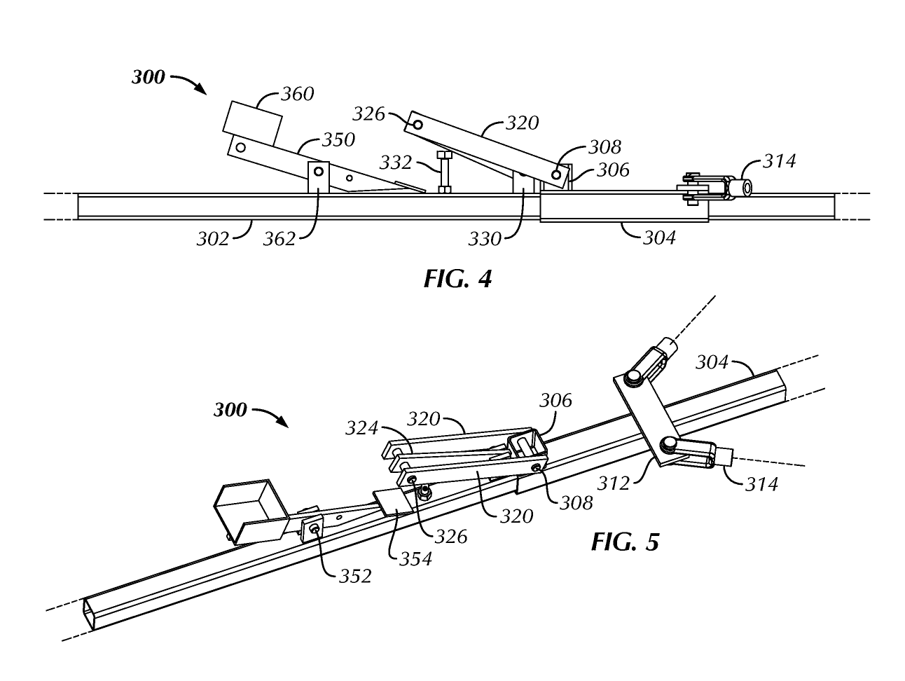

One embodiment of a gate latching and release mechanism 300 is shown in FIGS. 4, 5 and 6. As seen in FIG. 1, the gate release has a guide tube 302 longitudinally mounted on the top frame 150 of the chute 100. A slider tube 304 is a short section of tubing which has a slip fit to the exterior of the guide tube 302 and is slidably mounted on the guide tube.

The slider tube 304 has a symmetrical transversely extending horizontal plate 312 mounted on its upper surface towards the end of the slider tube 304 facing the exit gate 170. This plate 312 overhangs the sides of the slider tube 304 and has a vertical through hole penetrating each end of the transverse plate 312. These holes are each pivotably engaged to an exit gate linkage 314. The opposed ends of the two exit gate linkages 314 are each attached either a righthand or a lefthand exit gate 170. Thus, if the slider tube 304 slides forward towards the exit gate 170, the rods of the exit gate linkages 314 will also move forward and allow the exit gate to open.

The first end of the slider tube 304, facing the entry gate 160 has an upwardly extending slider pivot mount 306 which pivotably mounts a horizontally extending slider pivot pin 308. A pair of laterally spaced apart driver bars 320 is pivotably attached at their first ends to the slider pivot pin 308. At the second ends of the driver bars 320, a transverse link pivot pin 326 connects the driver bars 320 to a first end of a somewhat shorter swing bar 324 located in the vertical midplane between the two driver bars 320. The second end of the swing bar 324 is pivotably mounted by a transverse swing bar pivot pin 328 to an upwardly projecting bar pivot mount 330 positioned on the upper side of the guide tube 302 on the entry gate side of the slider tube 304.

As seen in FIGS. 4, 5 and 6, the interconnected driver bars 320 and swing bar 324 constitute a linkage which permits the slider tube 304 to be moved reciprocably along the axis of the guide tube 302. An adjustable travel stop screw 332 controls the movement of the slider tube 304 towards the entry gate end of the chute. This consequently limits how far closed the exit gate halves 170 can move. Normally, the interconnected driver bars and the swing bar are in a stable position when the exit gate is closed. The location of the upper end of the travel stop screw 332 is adjusted to ensure this condition. The length of the first and swing bars is selected to allow opening of the exit gate by the desired amount.

A flipper bar 350 provides an actuator for the release of the latching mechanism. The flipper bar 350 generally has an “L” like shape. The flipper bar 350 has a transverse pivot pin hole at approximately the midpoint of its long leg, and its short leg extends upwardly. A rectangular flipper plate 354 is mounted on a first end of the long leg of the “L” and a flat target surface 360 is mounted on the upper end of the short leg of the “L”.

The flipper bar 350 is installed by inserting a pivot axis pin 352 through both the pin hole in the flipper bar 350 and the flipper mounting plates 362 on the upper side of the guide tube 302 on the entry gate side of the slider tube 304. The installed flipper bar 350 has its flipper plate adjacent the travel stop 32. At its entry gate end, the flipper bar 350 mounts a target surface 360, such as a box or a plate. The opposed end of the flipper bar 350 mounts a transverse flipper plate 354. The location of the pivot axis of the flipper bar 350 is selected so that the flipper plate 354 at the exit gate end of the flipper bar 350 is positioned under the link pin 326 joining the driver and swing bars. Normally, the flipper plate 354 is bearing against the upper side of the guide tube 302 and the target surface 360 is elevated.

When the drive bars 320 and the swing bar 324 are in the position shown in FIGS. 4 and 5, they are stable, in spite of the compression force of the springs in the exit gate operating link 240 urging the exit gates to open and the cojoined bars to rotate in a clockwise direction.

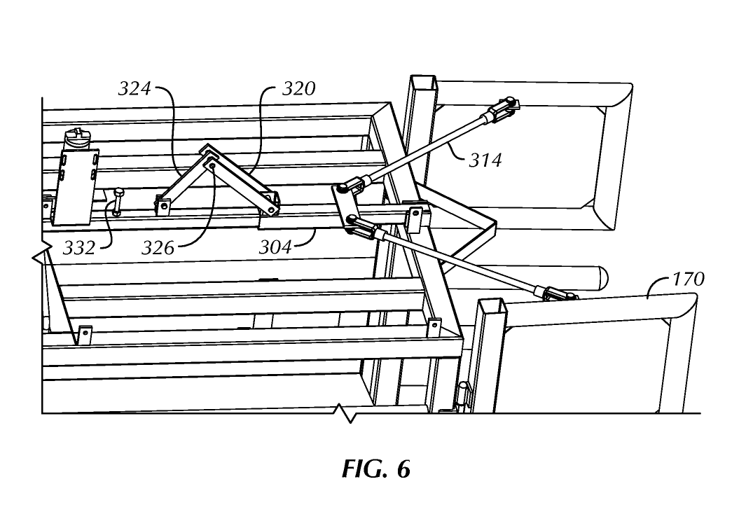

When a weight hits the target surface 360, the weight causes the target surface 360 to move toward the guide tube 302 and the flipper plate 354 to move upward and hit the cojoined drive and swing bars where they are pivotably connected by the link pin 326. The impact of the flipper plate 354 on the cojoined ends of the driver bars and swing bar causes the cojoined bars to rotate upwardly (clockwise from the position shown in FIGS. 4 and 5) to an unstable position. This unstable position of the cojoined bars allows the slider tube 304 to move toward the exit gate 170 in response to opening forces stored in the exit gate operating link 240. As the slider tube 304 moves toward the exit gate, the exit gate links 314 will also move forward and allow the exit gate 170 to open as illustrated in FIG. 6

### First Embodiment of a Control Mechanism for the Gate Release Actuator

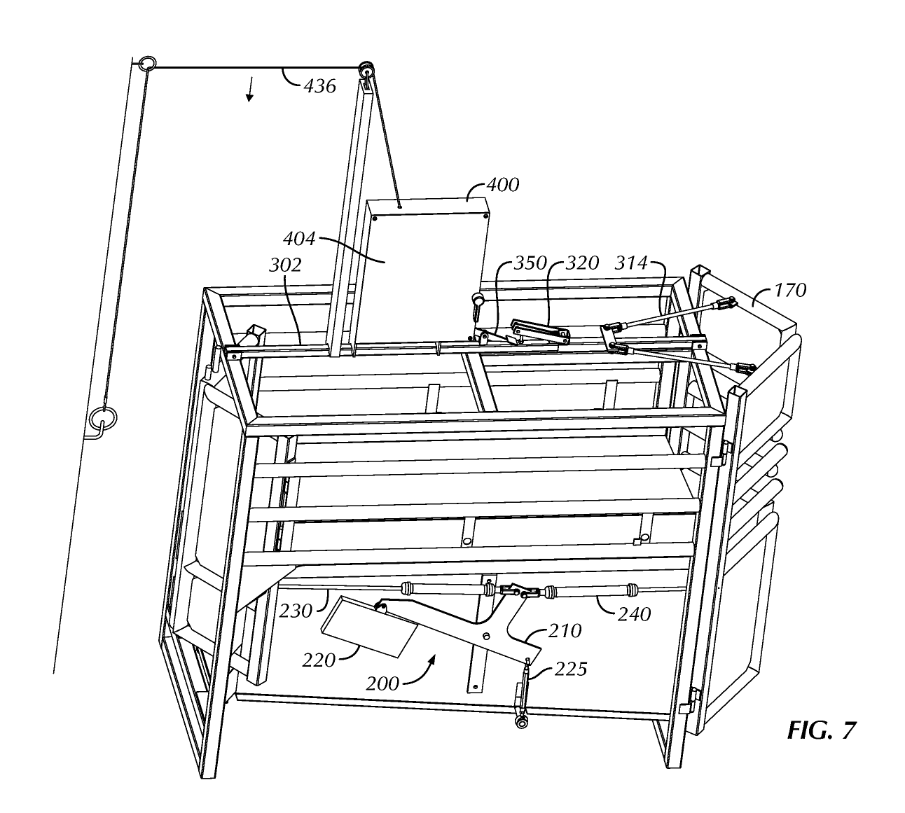

A first embodiment of an actuator control mechanism 400 is shown mounted on the guide tube 302 of the chute 100 in FIG. 7. The actuator control mechanism 400 interacts with the gate release mechanism by controlling the timing and the impact of a weight on the target surface 360 of the flipper bar 350.

The actuator control assembly 400, best seen in FIGS. 7 and 8, has a rectangular prismatic housing structure 402 fixedly attached by transverse vertical plate legs to the guide tube 302 on the longitudinal vertical midplane of the tube. The housing 402 is a thin wall plate fabrication which has an interior dimension transverse to the vertical longitudinal midplane of the chute 100. The housing 402 is openable on one of its largest sides, so it is provided with flanges around its open edges so that screws can be used to attach a flat cover plate 404.

On the lower corner of the housing on the chute exit side, a flipper cutout 406 permits the target surface 360 and a portion of the flipper bar 350 to be located within the interior of the housing. The flipper cutout 406 includes a substantially rectangular section cut from the bottom side of the housing 402 and an adjoining relatively narrow slot cut from the first vertical side of the housing facing the exit gate when the control mechanism is mounted on the chute 100.

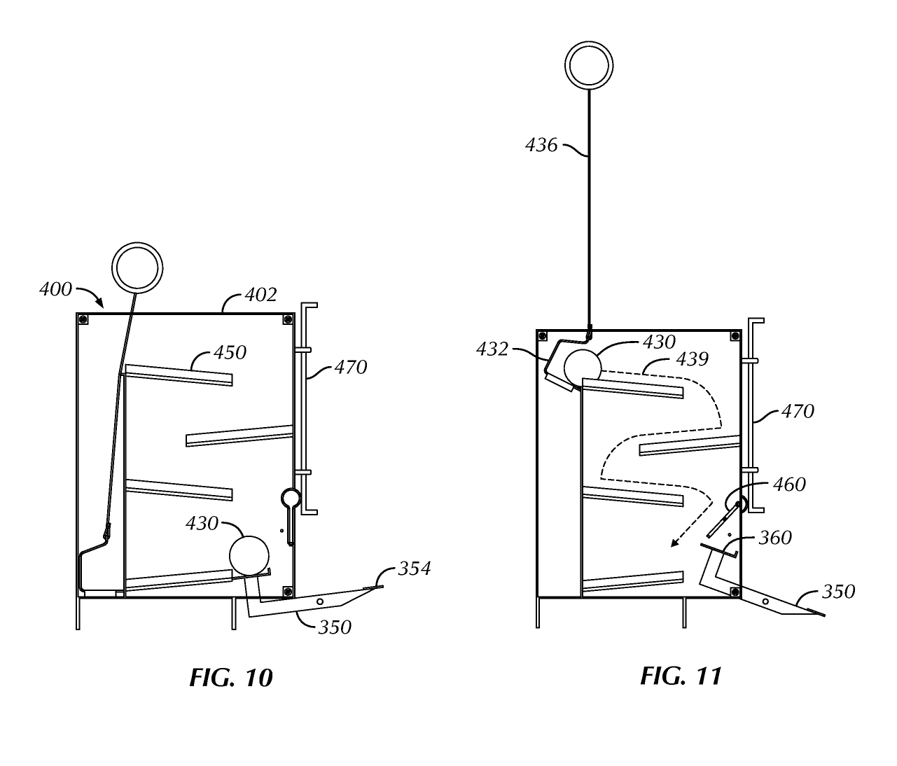

The flipper cutout 406 is large enough to allow a portion of the flipper bar 350 located within the housing 402 to move through the lower corner of the housing when a weight hits the target surface 360 and rotates the target surface downward as illustrated in FIG. 10.

On the side of the housing 402 opposed to the cutout 406, a vertical transverse partition 410 is installed adjacent a second vertical housing wall. At its lower end, the partition 410 has an approximately square opening 412 large enough for a ball 430 to pass through. The opening is spaced above the horizontal lower side of the housing to be in alignment with a lower guide ramp 450. At the upper end of the partition 410, the partition has a small horizontal lip 414 projecting toward the second vertical wall of the housing.

A series of inclined guide ramps 450 are attached to the largest side of the interior of the housing 402. The guide ramps 450 are channel sections, wherein the legs of the channels are short vertical segments which have a close fit between the largest side of the interior of the housing and the installed cover plate 404.

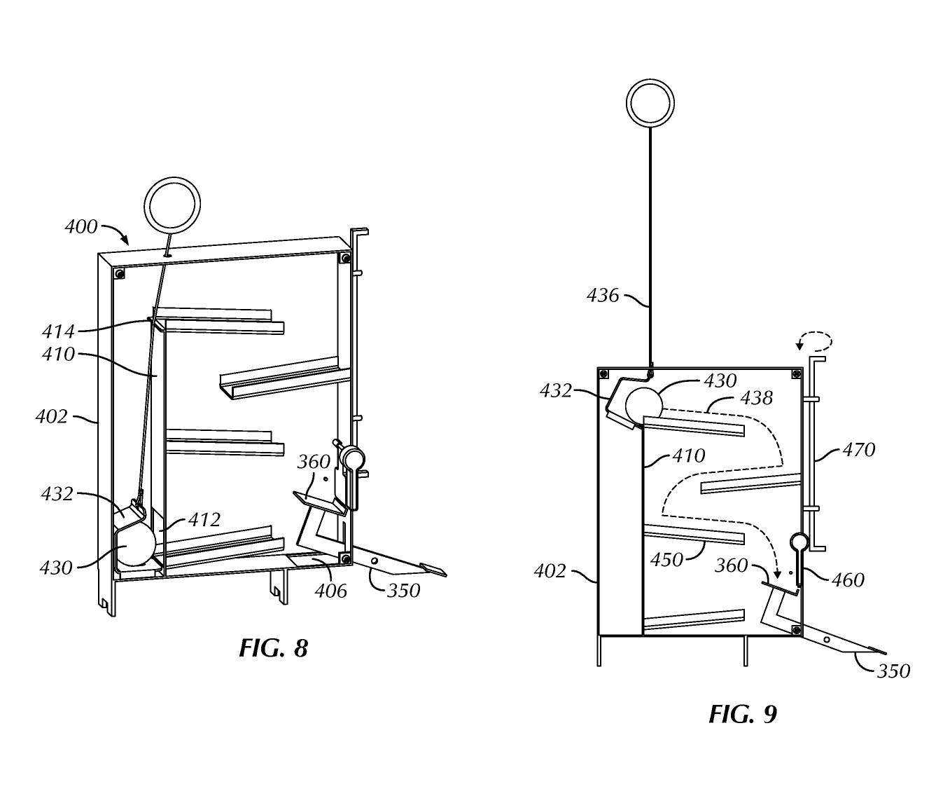

The number and length of the guide ramps as well as the angle of inclination of the ramps is selected to determine the travel time for a ball 430 to pass from the partition end of a topmost guide ramp to the bottommost guide ramp. For example as shown in FIG. 9, one embodiment of the actuator control mechanism 400 has four guide ramps.

The uppermost guide ramp 450 is attached to the upper end of the vertical partition 410 so that the upper surface of the ramp channel matches the upper surface of the installed vertical partition. The ramp is inclined such that the other end of the ramp is slightly lower than the end attached to the partition 410. For example, the lower end of the guide ramp may be 0.5 to 1.0 inch lower than the end attached to the partition. The length of the guide ramps 450 is less than the span between the partition 410 and the first vertical wall on the flipper cutout side of the housing 402.

The second guide ramp 450 is attached to the first vertical wall of the housing 402. The second guide ramp generally has about the same slope as the first guide ramp, but slopes in the opposite direction. The third guide ramp 450 is typically parallel to the first guide ramp and is attached at its higher end to the partition 410. The fourth guide ramp 450 is generally parallel to the second guide ramp. The lower end of the fourth guide ramp 450 is mounted to the partition 410 such that the upper surface of the channel is flush with the bottom horizontal edge of the opening 412 cut through the vertical partition 410.

As seen in FIG. 8, a lift tray 432 fabricated from plate with a constant width has a horizontal bottom portion, an upwardly extending vertical side, an inclined inwardly extending arm, and a short upwardly extending vertical section. The width of the lift tray 432 is such that it has a loose slip fit between the second vertical wall of the housing 402, the vertical partition 410, the largest wall of the housing and the installed cover plate 404. A through hole in the center of the short vertical section of the lift tray 432 serves as an attachment point for a lift line 436.

The lift line 436 is a string or cord that may have a ring attached to its upper end. The lift line 436 passes from the top of the lift tray up through the top of the housing 402. As seen in FIG. 8, a vertical hole on the longitudinal midplane of the housing 402 and located slightly to the right of the vertical partition. 410 serves as a guide for the lift line 436. The upper end of the lift line 436 may be directly pulled by the operator to lift the lift tray 432. Alternatively, the lift line 436 may pass through the top of the housing 402, over an elevated pulley and be attached to a stationary mounting as illustrated in FIG. 7. When the lift line is attached as shown in FIG. 7 to a stationary mounting, a roper mounted on a horse can quickly pull down on the lift line 436 thereby pulling the lift tray upward toward the top of the housing.

When an animal is penned within the chute 100, an operator or rider can open the exit gate 170 by quickly pulling the lift line 436 until the lift tray 432 abuts the horizontal partition lip 412 at the upper end of the vertical partition of the housing 402 causing the lift tray to release the ball 430 onto the uppermost guide ramp as shown in FIG. 9.

As the ball 430 rolls off the lift tray 432, it begins to roll down the upper guide ramp 450 and then falls off the lower end of that ramp. The angle of incline of the ramps 450 is such that the ball rolls relatively slowly. While the ball is traveling down the guide ramps 450, the weight of the lift tray 432 causes the lift tray to return to its original position on the bottom of the housing 402.

The falling ball 430 reaches the end of the first ramp and falls onto and rolls down the second ramp 450 until it rolls off onto the third ramp. The path taken by the ball 430 is indicated by the dashed line 438 in FIG. 9. When the ball rolls off the end of the third ramp 450, it impacts the upwardly positioned target surface 360 of the flipper bar 350. The energy of the impact plus the weight of the ball 430 causes the flipper bar to rotate in a counterclockwise direction from its at rest position shown in FIG. 9 until its lower elbow passes through the flipper cut out 406 and abuts the upper side of the guide tube 302. This permits the ball 430 and flipper bar 350 to assume the position shown in FIG. 10. In this position, the ball 430 rolls off the target surface 360 of the flipper bar onto the fourth guide ramp. The ball continues to roll down the fourth ramp 450, through the hole 412 in the vertical partition, and finally comes to rest on the repositioned lift tray 432.

As the flipper bar 350 rotates, the flipper plate 354 moves upwardly and impacts the linkage consisting of the cojoined drive bars 320 and the swing bar 324. The impact of the flipper plate destabilizes and rotates the linkage in a clockwise direction from that shown in FIG. 4. The rotation of the linkage permits the slider tube 304 to travel sufficiently to open the exit gate and allow the animal to exit the chute. The movable floor 180 remains depressed as long as the animal exerts weight on it.

After the animal departs the chute, the eccentric counterweight 220 urges the exit gate 170 to close and the entry gates 160 to open as the movable floor assembly rises. This is due to the moment exerted on the gate operator bar 210 due to the weight of the counterweight 220.

Referring to FIG. 1, the chute 100 is shown in its first position ready to receive an entering animal. In this position, the entry gates 160 are open, the movable floor assembly 180 is in its upper position, and the exit gates 170 are closed. The operator linkage assembly 200 has its counterweight 220 at its lower position with the upwardly projecting arm of the gate operator for 210 inclined towards the entry end of the chute 100.

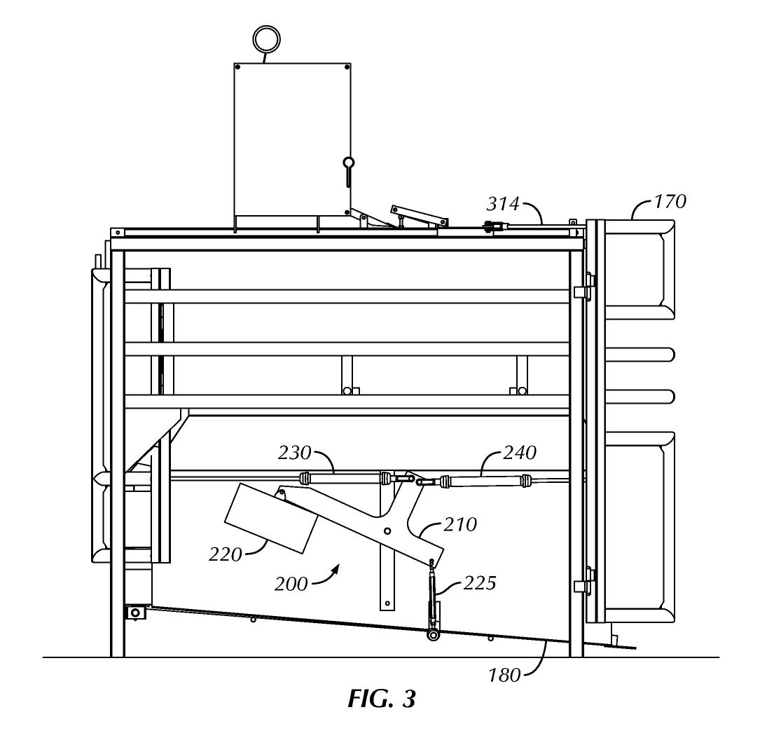

As seen in FIGS. 2 and 3, when an animal enters the entry gates 160 its weight causes the movable floor assembly 180 to rotate downwardly about its floor hinge mounting plates. This in turn causes the upwardly projecting arm of the operator bar 210 to rotate in a clockwise direction from its position when the entry gates 160 are open. This rotation causes the springs of the exit gate operating link 240 to be compressed and hence to urge the exit gates 170 to open. However, restraint of the exit gates 170 by the gate latching and release mechanism 300 prevents the exit gates from opening. At this point, the ball 350 in the actuator control assembly 400 is in its at rest position as shown in FIG. 8.

With the continual use of the chute and the actuator control assembly 400 using a ball to activate the opening mechanism, the mount of the rider using the chute, as well as the animal penned within the chute, can become accustomed to hearing the ball 430 dropping through the actuator control housing and attempt to move prematurely. This situation is avoided by training the animals not to move until the exit gates 170 actually open. This training is accomplished using a diverter mechanism. The diverter mechanism prevents the ball from dropping on the target surface 360, even though the ball rolls down the guide ramps and makes the noise associated with the gate opening when the diverter is not used.

One embodiment of a diverter mechanism, shown in FIGS. 9 and 11, includes a hinged rotatable flap 460 attached to the first vertical wall of the actuator control, housing 402 and a selectably engaged diverter bar 470 that can be positioned to engage and open the flap 460 or positioned to disengage and allow the flap to close.

An actuator control mechanism 400 with the diverter mechanism installed has a hole in the first vertical side of the housing 402. The bottom edge of the hole is slightly above and adjacent to the target surface 360 of the flipper bar 350 when positioned in its at rest position. Thus, when the flap 460 is closed and abuts the first vertical wall of the housing, the flap 460 does not interfere with the falling of the ball 430 onto the target surface 360 from the bottom of the third guide ramp 450 as shown in FIG. 9.

The flap 460 can be selectably engaged to interfere with the falling of the ball 430 onto the target surface 360 from the bottom of the third guide ramp 450 by a number of different means. For example, a diverter bar 470 can be used to selectably engage the flap 460 to move the flap into the path of the falling ball 430 as shown in FIG. 11.

The diverter bar 470 is an elongated bar having a short leg extending at a right degree angle from each end of the bar, where the two short legged extensions extend away from the bar in the same direction. The diverter bar 470 is rotatably mounted on the exterior of the first vertical wall of the housing 402 with an upper short legged extension positioned above the top side of the housing 402 and the lower short legged extension positioned just below the hinge attached to the upper edge of the flap 460. The diverter bar 470 is not engaged when it is turned with its two short legged extensions facing away from the housing 402.

The diverter bar 470 is easily rotated to an engagement position. For example, when the diverter bar 470 is rotated about 180 degrees to point its short legged extensions toward the housing, the upper extension is positioned over the top surface of the housing and the lower extension enters the hole in the first vertical side of the housing and pushes the hinged flap 460 inward towards the partition 410 such that the flap 460 is angled over with the target surface 360 to prevent the ball from striking the target surface. Thus, in the engagement position of the diverter bar, the flap 460 is held open by the lower extension of the diverter bar at an angle of approximately 45 degrees from vertical, as seen in FIG. 11. The diverter bar 470 in the engaged position offers sufficient force against the flap 460 to retain the flap in its inclined position even when the flap is impacted with a moderate force such as the falling ball 430.

The path taken by the diverted ball 430 is indicated by the dotted line 439 shown in FIG. 11. When the bail 430 is dropped with the diverter bar in its engaged position, the ball hits the flap 460 as the ball rolls off the lower end of the third guide rail and falls onto the fourth guide rail. As the rider uses the diverter during training, the horse gradually becomes desensitized to the noise of the ball dropping and awaits the rider's instructions to move rather than automatically move at the sound of the ball dropping.

### Second Embodiment of an Actuator Control Mechanism

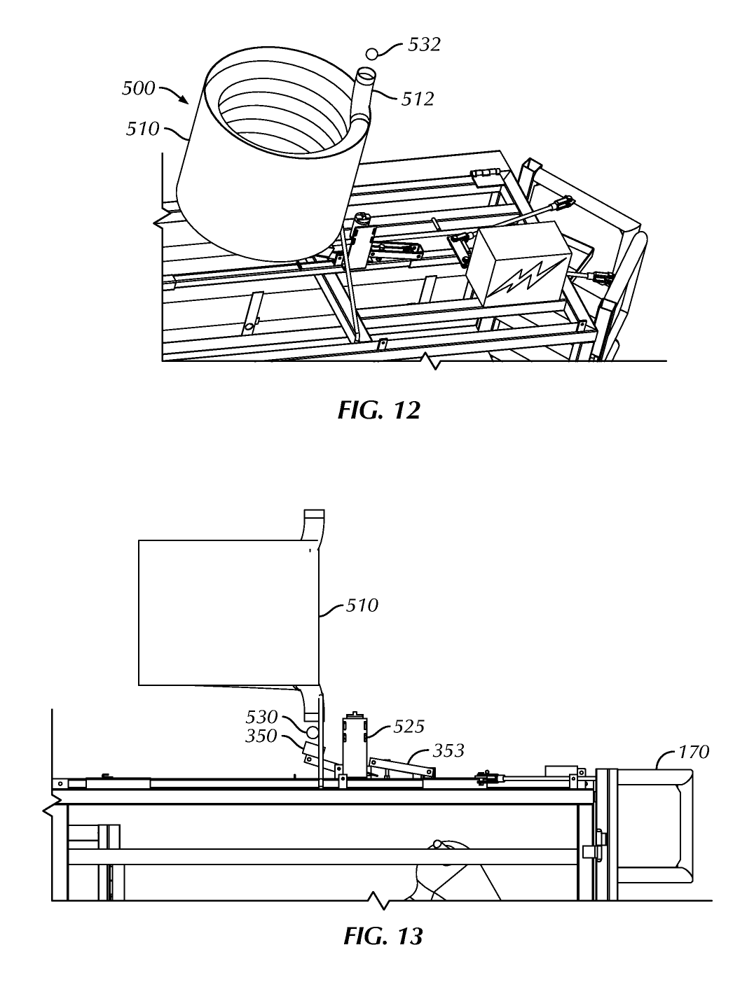

A second embodiment of an actuator control mechanism 500 is shown mounted on the top frame 150 of the chute 100 in FIG. 12. The actuator control mechanism 500 interacts with the gate release mechanism by controlling the timing and the impact of a weight on the target surface 360 of the flipper bar 350. The operation of the second embodiment actuator control mechanism 500 on the gate latching and release mechanism 300 is similar to that described above for the first embodiment of the actuator control mechanism 400.

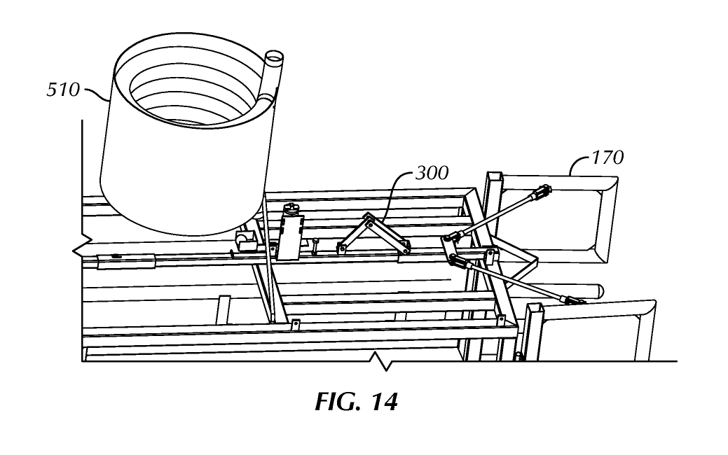

The actuator control assembly 500, best seen in FIGS. 12 to 14, includes a large diameter cylinder 510 with an open top and a hole in the transverse bottom end. A spiraled tube 512 is coiled inside the tank with its open upper end turned up and its open lower end turned down. The spiraled tube provides free passage to a trigger ball 530 used to impact the target surface 360 of the flipper bar 350. The outlet of the spiraled tube 512 is aligned with the target surface 360. The spiraled tube 512 is adjusted in length and curvature so that it takes about 12-20 seconds for the ball 530 to pass through the spiral tube and hit the target surface to open the exit gate 170.

Opening of the exit gate causes the calf to depart. Removal of the weight of the calf from the pivoting floor 180 permits the pivoting floor to rise, thereby energizing springs which urge the exit to close and the entry gate to open. In addition, the flipper bar 350 and the linkage of the cojoined driver bars 320 and the swing bar 324 are returned to their original, untriggered positions so that the chute operating cycle can be repeated. The gate latching and release mechanism 300 may be returned to its original position either through solely mechanical means (such as a biasing means for the flipper bar) or by using a resetting solenoid 525. Whenever, a resetting solenoid is used to return the flipper bar 350 to its original position, the upper side of the roping chute will preferably mount a battery to power the solenoid. The battery is used to provide operative power to a downwardly acting resetting solenoid.

The reason for having a roping chute is to provide practice in roping a running calf. To initiate operation, a calf is herded into the open entry gate of the chute. When the calf stands on the pivoting floor, the weight of the calf causes the floor to depress. The link between the pivoting floor 180 and the gate operator bar 210 pulls the exit end of the gate operator bar 210 downward as the floor lowers. This action compresses a spring on in the cylinder of the exit gate operating link 240 so that it urges the exit gate 170 to open. At the same time, a compression spring on the rod end of the entry gate operating link 230 urges the entry gate 160 closed.

At the same time, while the exit gate is urged to open by the compression spring in the exit gate operating link 240, the stability of the cojoined linkage bars of the gate latching and release mechanism 300 does not permit the exit gate to open, even though it is strongly urged to do so by the bias of the exit gate operating link.

At this point, the exit gate 170 can be selectively caused to open by the dropping of the trigger ball 530 in the upper entrance end of the spiraled tube 512. The elevated position of the spiraled tube is conveniently located for access by a rider (not shown), who can take the ball from a storage area (not shown) on top of the chute 100.

The ball 530 requires a few seconds (usually about 12 to 20 seconds) to travel the length of the tube 512 and then drop onto the target surface 360. This elapsed time permits the rider to ready the loop of his rope and his horse. The impact of the ball on the target surface causes the flipper bar 350 to rotate so that its end under the cojoined ends of the driver bars and the swing bar impacts those links, causing the linkage to rotate upwardly (clockwise from the position shown in FIGS. 4 and 5) to an unstable position. When the linkage is destabilized, the slider can move in the direction of the exit gate in response to opening forces from the exit gate operating link 240. This permits the calf to exit. In the meantime, the ball 530 has fallen off of the target surface 360 of the flipper bar and is retained in a ball receptacle on the top of the guide tube.

If the rider decides to delay the opening of the exit gate, a diverting mechanism (not shown) for directly sending the trigger ball from the outlet of the spiral tube to the ball receptacle instead of allowing it to hit the ball target surface can be selectably engaged by the rider. This alternative diverting mechanism is useful in training a calf to be calm in the chute and to be prepared for a precise exit.

After the calf departs the chute, the counterweights of the gate operator bars 210 and the compressed springs of the gate operating links urge the exit gate to close and the entry gate to open. Gate operation cannot occur instantly because of the damper cylinders and the need to lower the exit end of the flipper bar 350. The flipper bar is lowered either by a purely mechanical means, such as a spring loaded biasing means or by a resetting solenoid.

The roping chute of the present invention may be totally operated without electronics as described above, or may be operated with only a resetting solenoid used to reset the flipper bar.

A variety of modifications to the actuator control mechanism and the gate latching and release mechanism can be made without departing from the spirit of the invention.

What is claimed is:

1. A gate opener for opening a gate including:
a. a weight;
b. a gate opening mechanism;
c. an actuator for the gate opening mechanism, wherein the weight striking the actuator initiates the opening of the exit gate;
d. an elevating mechanism for lifting the weight a set height;
e. a release mechanism for releasing the weight at the set height; and
f. a delay mechanism for extending a time from when the weight is released from the set height to when the weight strikes the actuator.

2. The gate opener of claim 1, further including a diverter for diverting the released weight to avoid striking the actuator and opening the gate.

3. The gate opener of claim 1, wherein the actuator is a pivotable flipper bar.

4. The gate opener of claim 1, wherein the weight is a ball and the delay mechanism is a number of inclined ramps.

5. The gate opener of claim 4, wherein the time required for the ball to travel down the inclined ramps and strike the actuator is related to the number of ramps and an angle of inclination selected for each of the ramps.

6. The gate opener of claim 1, wherein the weight is a ball and the delay mechanism is a spiraled ramp.

7. The gate opener of claim 1, wherein the gate opening mechanism includes a rotating linkage, wherein when the linkage is in a first position the gate resists an opening force and when the linkage is rotated to a second position the gate opens in response to the opening force.

8. The gate opener of claim 7, wherein the actuator is a flipper bar rotatable between a resting position and a striking position, the flipper bar having a first end and a second end, wherein the second end of the flipper bar strikes the linkage to rotate the linkage into the second position whenever the weight strikes the first end of the flipper bar and rotates the flipper bar to the striking position.

9. A gate opener for opening an exit gate of a livestock chute including:
a. a gate opening mechanism including a rotating linkage, wherein when the rotating linkage is in a first stable position the opening, mechanism resists opening the exit gate to an opening force and when the rotating linkage is in a second unstable position the exit gate opens in response to the opening force;
b. an actuator for the gate opening mechanism having a flipper bar rotatable between a resting position and a striking position, the flipper bar having a first end and a second end, wherein the second end is positioned under one end of the rotating linkage when the flipper bar is in the resting position; and
c. an actuator control having
(i) a weight,
(ii) an elevating mechanism for lifting the weight a set height,
(iii) a release mechanism for releasing the weight at the set height; and
(iv) a delay mechanism for extending a time from when the weight is released from the set height to when the weight strikes the first end of the flipper bar in the resting position to rotate the flipper bar to the striking position wherein the second end of the flipper bar impacts the one end of the rotating linkage causing the linkage to rotate to the unstable position.

10. The gate opener of claim 9, wherein the actuator control further includes a diverter for diverting the released weight from striking the first end of the flipper bar.

11. The gate opener of claim 9, wherein the weight is a ball and the delay mechanism is a number of inclined ramps, whereby the time required for the ball to travel down the inclined ramps and strike the first end of the flipper is related to the number of ramps and an angle of inclination selected for each of the ramps.

12. The gate opener of claim 11, wherein the delay mechanism has a series of inclined ramps, wherein the series of ramps are positioned such that the ball rolls downward from a first ramp onto a second ramp and then onto a third ramp before striking the first end of the flipper bar.

13. The gate opener of claim 12, wherein the first ramp and the third ramp are parallel to each other.

14. The gate opener of claim 9, wherein the rotating linkage includes a pair of driver bars with a first end of each driver bar in communication with the exit gate, a swing bar having a first end mounted to the livestock chute, wherein a second end of the driver bars and a second end of the swing bar are pivotably cojoined.

15. A gate opener for opening an exit gate of a livestock chute including:
a. a gate opening mechanism including a rotating linkage, wherein when the rotating linkage is in a first stable position the opening mechanism resists opening the exit gate to an opening force and when the rotating linkage is in a second unstable position the exit gate opens in response to the opening force;
b. an actuator for the gate opening mechanism having a flipper bar rotatable between a resting position and a striking position, the flipper bar having a first end and a second end, wherein the second end is positioned under one end of the rotating linkage when the flipper bar is in the resting position; and
c. an actuator control having a housing that encloses
(i) a ball,
(ii) a lift tray for an elevating the ball a set height,
(iii) a release mechanism for releasing the weight at the set height, and
(iv) a series of inclined ramps, wherein the series of ramps are positioned such that the ball rolls downward from a first ramp onto a second ramp and then onto a third ramp before striking the first end of the flipper bar in the resting position to rotate the flipper bar to the striking position thereby impacting one end of the rotating linkage to rotate it to the second unstable position.

16. The gate opener of claim 15, wherein a surface of an upper end of the inclined first ramp is at the set height.

17. The gate opener of claim 16, wherein a lift line is attached to an upper end of the lift tray.

18. The gate opener of claim 17, wherein an operator pulling the lift line elevates the lift tray to the set height to release the ball on the upper end of the inclined first ramp.

19. The gate opener of claim 18, wherein when the operator releases the lift line and the ball has moved off of the lift tray will fall back to an original position.

20. The gate opener of claim 19, wherein when the ball rotates the flipper bar to the striking position the ball falls off the first end of the flipper bar onto a fourth inclined ramp and returns to the lift tray.

21. The gate opener of claim 15, wherein the actuator control has a hinged flap that when selectably engaged interferes with the ball striking the first end of the flipper bar.
